(19) United States
(12) Patent Application Publication
(10) Pub. No.: US 2025/0361085 A1
(43) Pub. Date: Nov. 27, 2025

(54) STORAGE SYSTEM AND STORAGE CONTAINER

(71) Applicant: Ocado Innovation Limited, Hatfield (GB)

(72) Inventor: Eric BOATENG, Hatfield (GB)

(21) Appl. No.: 19/294,700

(22) Filed: Aug. 8, 2025

Related U.S. Application Data
(63) Continuation of application No. PCT/EP2024/053519, filed on Feb. 12, 2024.

(30) Foreign Application Priority Data
Feb. 10, 2023 (GB) 2301935.9

(51) Int. Cl. B65G 1/04; F25D 13/04; F25D 25/04

(52) U.S. Cl. CPC B65G 1/0464; F25D 13/04; F25D 25/04; F25D 2323/02

(57) ABSTRACT

A multi-temperature storage system comprising a first enclosure comprising a grid framework structure comprising storage columns for storing stacks of containers, a track system for guiding a load handling device on the grid framework structure, a second enclosure configured to accommodate a load handling device; a cooling system configured to maintain a first temperature in a first temperature zone in the first enclosure lower than a second temperature in a second temperature zone in the second enclosure; an environmental controlled enclosure (ECE) comprising a first opening and a second opening for linking the first and second enclosures, an environmental control unit configured to heat or dehumidify air in the ECE; an environmental control system configured to control the environmental control unit to provide an environmental condition in the ECE in anticipation of opening the first door or the second door.

### CROSS-REFERENCE TO RELATED APPLICATIONS

This Application is a continuation of PCT International Patent Application No. PCT/EP2024/053519, filed on Feb. 12, 2024, which claims priority to UK Patent Application No. GB2301935.9, filed on Feb. 10, 2023, the entire contents of each of which are hereby incorporated by reference.

### TECHNICAL FIELD

The present invention relates to the field of storage and retrieval systems comprising robotic load handling devices operative on tracks located on a grid framework structure for handling storage containers stacked in the grid framework structure, and storage containers for use in such storage and retrieval systems.

### BACKGROUND

Some commercial and industrial activities require systems that enable the storage and retrieval of a large number of different products. One known type of system for the storage and retrieval of items in multiple product lines involves arranging storage containers (also known as bins or totes) in stacks on top of one another, the stacks being arranged in rows. The storage containers are removed from the stacks and accessed from above by load handling devices, removing the need for aisles between the rows and thereby allowing a large number of containers to be stored in a given space.

As shown in FIGS. 1 and 2, the storage containers 10, also known as bins or totes, are stacked on top of one another to form stacks 12. The stacks 12 are arranged in a grid framework structure 14 in a warehousing or manufacturing environment. The grid framework is made up of a plurality of storage columns or grid columns 11. Each grid in the grid framework structure has at least one storage column 11 for storage of a stack of containers. FIG. 1 is a schematic perspective view of the grid framework structure 14, and FIG. 2 is a top-down view showing a single stack 12 of storage containers 10 arranged within the grid framework structure 14. Each container or bin 10 typically holds a plurality of product items (not shown), and the product items within a storage container 10 may be identical, or may be of different product types depending on the application. Each storage container 10 may be used to store grocery items (i.e. food items), for example. Furthermore, the bins 10 may be physically subdivided to accommodate a plurality of different inventory items.

The grid framework structure 14 comprises a plurality of upright members or upright columns 16 that support horizontal grid members 18, 20. A first set of parallel horizontal grid members 18 is arranged perpendicularly to a second set of parallel horizontal grid members 20 to form a grid structure lying in a substantially horizontal plane and supported by the upright members 16. The upright members 16 and the horizontal grid members 18, 20 are typically manufactured from metal and typically welded or bolted together or a combination of both. The storage containers 10 are stacked between the upright members 16 of the grid framework structure 14, so that the grid framework structure 14 guards against horizontal movement of the stacks 12 of the storage containers 10, and guides vertical movement of the storage containers 10.

The top level of the grid framework structure 14 includes a track system 15 comprising a plurality of rails or tracks 22 arranged in a grid pattern across the top of the stacks 12. Referring additionally to FIG. 3, the rails 22 support a plurality of load handling devices or robotic load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12. The track system 15 can be integrated into the grid structure in the sense that the first and second sets of tracks are respectively integrated into the first and second set of grid members. Alternatively, the track system 15 can be separate to the grid structure in the sense that the first and second sets of tracks are respectively mounted to the first and second sets of grid members.

Each load handling device 30 comprises a vehicle body 32 which is arranged to travel in the X and Y directions on the tracks or rails 22 of the grid framework structure 14, above the stacks 12 (see FIG. 4). FIGS. 4 and 5 shows a load handling device 30 described in PCT Patent Publication No. WO2015/019055 (Ocado Innovation Limited) and International patent application WO 2015/140216 (Ocado Innovation Limited) comprising a vehicle body 32 equipped with a lifting mechanism 33 comprising a winch or a crane mechanism 35 to lift a storage container or bin 10, also known as a tote, from above. The crane mechanism 35 comprises a winch cable wound on a spool or reel and a grabber device 39. Typically, the lifting device comprises a set of lifting tethers 38 extending in a vertical direction and connected nearby or at the four corners of the grabber device 39 (one tether near each of the four corners of the grabber device) for releasable connection to a storage container 10. The grabber device 39 is configured to grip the top of the storage container 10 and lift it from a stack of containers in a storage system of the type shown in FIGS. 1 and 2. Typically, the grabber device 39 is configured as a lifting frame.

To grab a storage container 10, the grabber device 39 comprises four locating pins or guide pins nearby or at each corner of the grabber device 39 which mate with corresponding cut outs or holes formed at four corners of the storage container 10 and four gripper elements arranged at the bottom side of the grabber device 39 to engage with the rim of the storage container 10. The locating pins help to properly align the gripper elements with corresponding holes in the rim of the container. Each of the gripper elements comprises a pair of wings or legs that are collapsible to be receivable in corresponding holes in the rim of the storage container and an open enlarged configuration having a size greater than the holes in the rim of the storage container 10 in at least one dimension so as to lock onto the storage container 10. The wings are driven into the open configuration by a drive gear (not shown). More specifically, the head of at least one of the wings comprises a plurality of teeth that mesh with the drive gear such that when the gripper elements are actuated, rotation of the drive gear causes the pair of wings to rotate from a collapsed configuration to an open enlarged configuration (FIG. 7b).

The vehicle body 32 comprises an upper part and a lower part (see FIGS. 5A-5B). The lower part is fitted with two sets of wheels 34, 36, which run on rails at the top of the framework structure of the storage system. The upper part of the vehicle body 32 may house a majority of the bulky components of the load handling device. Typically, the upper part of the vehicle body houses a driving mechanism for driving both the wheels and the lifting mechanism together with an on-board rechargeable power source for providing the power to the driving mechanism and the lifting mechanism.

The lower part of the vehicle body 32 comprises a wheel assembly driven to enable movement of the vehicle in X and Y directions respectively along the rails. A first set of wheels 34, consisting of a pair of wheels 34 on the front of the vehicle body 32 and a pair of wheels 34 on the back of the vehicle body 32, are arranged to engage with two adjacent rails of the first set 22a of rails 22. Similarly, a second set of wheels 36, consisting of a pair of wheels 36 on each side of the vehicle body 32, are arranged to engage with two adjacent rails of the second set 22b of rails 22. One or both sets of wheels can be moved vertically to lift each set of wheels clear of the respective rails, thereby allowing the vehicle to move in the desired direction. When the first set of wheels 34 is engaged with the first set of tracks or rails 22a and the second set of wheels 36 are lifted clear from the tracks or rails 22, the wheels 34 can be driven, by way of a drive mechanism (not shown) housed in the vehicle body 32, to move the load handling device 30 in the X direction. To move the load handling device 30 in the Y direction, the first set of wheels 34 are lifted clear of the tracks or rails 22, and the second set of wheels 36 are lowered into engagement with the second set of tracks or rails 22a. The drive mechanism can then be used to drive the second set of wheels 36 to achieve movement in the Y direction. One or both sets of wheels can be moved vertically to lift each set of wheels clear of the respective rails, thereby allowing the vehicle to move in the desired direction on the track system.

The wheels are arranged around the periphery of a cavity or recess, known as a container-receiving recess 40, in the lower part. The recess 40 is sized to accommodate the storage container or bin 10 when it is lifted by the crane mechanism comprising a winch, as shown in FIGS. 5A-5B. When in the recess, the container is lifted clear of the rails beneath, so that the load handling device can move laterally to a different location. Whilst the recess 40 is shown in FIG. 4 arranged within the vehicle body 32, the container receiving space can be located below a cantilever as described in WO2019/238702 (Autostore Technology AS).

A typical storage and retrieval system 1 is shown in FIG. 3, the system having a plurality of load handling devices 30 active on the grid above the stacks 12. FIGS. 1 and 3 show the bins 10 in stacks 12 within the storage system. It will be appreciated that there may be a large number of storage containers or bins 10 in any given storage system and that many different items may be stored in the bins 10 in the stacks 12, each bin 10 may contain different categories of inventory items within a single stack 12.

Upon receipt of a customer order, a robotic load handling device operative to move on the tracks is instructed to pick up a storage bin containing the item of the order from a stack in the grid framework structure and transport the storage bin to a pick station whereupon the item can be retrieved from the storage bin. Typically, the load handling device transports the storage bin or container to a bin lift device that is integrated into the grid framework structure. A mechanism of the bin lift device lowers the storage bin or container to a pick station. Alternatively, the storage bin is lowered by the lifting mechanism of the robotic load handling device to the pick station.

A grid framework structure normally has at least one grid cell or storage column which is used not for storing storage containers, but which comprises a location where the load handling devices can drop off and/or pick up storage containers so that they can be transported to a second location (not shown in the prior art figures) where the storage containers can be accessed from outside of the grid framework structure or transferred out of or into the grid framework structure. Within the art, such a location is normally referred to as a “port” and the grid cell or storage column in which the port is located may be referred to as a “delivery column”. The storage columns typically comprise two delivery columns. A first delivery column may, for example, comprise a dedicated drop-off port where the robotic load handling vehicles or load handling vehicles can drop off storage containers to be transported through the delivery column and further to the pick station, and a second delivery column may comprise a dedicated pick-up port where the robotic load handling vehicles can pick up storage containers that have been transported through the second delivery column from the pick station, i.e. storage containers are fed into the pick station via the first delivery column and exit the access station via the second delivery column.

At the pick station, the item is retrieved from the storage bin. Picking can done manually by hand or by a robot. After retrieval from the storage bin, the storage bin is transported to a second bin lift device whereupon it is lifted to grid level to be retrieved by a load handling device and transported back into its location within the grid framework structure. Alternatively, the storage bin can be picked up by the lifting mechanism of the robotic load handling device through the pick-up port. A control system and a communication system keeps track of the location of the storage bins and their contents within the grid framework structure.

As individual storage containers are stacked in vertical layers in storage columns, their locations in the grid framework structure or “hive” may be indicated using co-ordinates in three dimensions to represent the load handling device or a container's position and a container depth (e.g. container at (X, Y, Z), depth W). Equally, locations in the grid framework structure may be indicated in two dimensions to represent the load handling device or a container's position and a container depth (e.g. container depth (e.g. container at (X, Y), depth Z). For example, Z=1 identifies the uppermost layer of the grid, i.e. the layer immediately below the rail system, Z=2 is the second layer below the rail system and so on to the lowermost, bottom layer of the grid.

As electronic commerce (e-commerce) continues to grow and overtake conventional brick and mortar retail practices, many businesses are facing challenges of maintaining or gaining relevance in an online marketplace and being able to compete with prominent players in the space. A typical supply chain involve the storage and retrieval of a large number of different products. For example, e-commerce and retail platforms that sell multiple product lines require systems that are able to store hundreds of thousands of different product lines having different temperature requirements. Different product items need to be maintained at different prescribed temperatures within a storage system, while the product items are stored and/or transported, and/or while orders are fulfilled. Some product items need to be maintained in a chilled or frozen environment to ensure freshness, while other product items can be stored or transported at ambient temperature. For example, where an order of one or more items involves the delivery of food and grocery goods that are of a perishable nature, storage of goods must adhere to strict temperature and environmental requirements, e.g. chilled or frozen temperature. For example, some types of food require a cool temperature environment (typically temperatures between 1° C.-8° C.), some types of food require an even colder temperature environment (typically temperatures lower than −15° C.), and other types of food require a higher temperature environment (typically temperatures above 10° C.).

Conventional multi-temperature storage and retrieval systems typically require a walk-in cooler or freezer to be pre-constructed or additional components to be installed around the storage and retrieval system discussed above, which substantially expands the footprint of the storage and retrieval system and increases the cost and complexity of installing and operating the storage and retrieval system across multiple environmentally controlled zones. As a result, there has been a need for a freestanding, high density, automated storage and retrieval system with multiple integrated, environmentally controlled zones that removes the need of separate walk-in, environmentally controlled zones that operate independently of the storage and retrieval system.

In attempt to adapt an existing automated storage and retrieval system to provide storage for sensitive item, e.g. chilled or frozen items, WO2015124610 (Autostore Tech AS) relates to a storage system for receiving and storing processed refrigerated and frozen food products where there is provided thermal insulation between at least a section of the grid structure and the remotely operated vehicle. The system comprises insulating covers arranged in the top level of the grid structure. The insulating covers provide a thermal barrier towards the remotely operated vehicle as well as contributing to maintaining the desired temperature in the bins in the grid structure. The insulating covers are arranged to be movable by means of the remotely operated vehicle. The vehicle can move one insulating cover to another cell in the grid, or hold it temporarily while a bin is removed from the stack.

WO2021198170 (Autostore Tech AS) relates to an automated storage and retrieval system for storing specialized goods in storage containers in an isolating housing, having walls and a roof. Openable and closable hatches are arranged in the roof. A storage tower is arranged inside the isolating housing such that the storage tower being accessible to a container handling vehicle though the hatch. The storage tower has a number of vertically stacked, horizontally movable container supports in the form of shelves upon which may rest a plurality of storage containers and one or more openings corresponding in size to a storage container such that storage containers may pass therethrough. The container supports may align their openings to form a tower port beneath a hatch, through which the container handling vehicle may lower its lifting device though the hatch, down the tower port, and access the target container.

In both teachings, there is a requirement that the thermal insulation covering of the grid cell has to be removed or moved aside so that a container handling vehicle operating on the grid structure is able to gain access to one or more storage containers in storage. Not only does this introduce an additional step when retrieving storage containers from the storage system but there is no guarantee that the thermal insulation covers of the grid cells will provide adequate insulation to prevent the ingress of warmer air into the grid structure from the ambient region above the grid structure. To prevent the ingress of air from the ambient region into the grid structure, it is essential that the grid cells are adequately sealed from the ambient region above the thermal insulation covers. However, the use of thermal insulation covers for each of the grid cells introduces an additional complexity of the need to be easily removal in order to gain access to one or more storage container in storage in the grid structure.

To mitigate this problem, a fleet of robotic load handling devices are disposed in a chilled, or freezer environment. In these facilities, the robotic load handling devices reside and operate in the chilled or freezer on a full-time basis. Whilst having a fleet of load handling devices operating in the chilled or freezer environment on a full-time basis automates the storage and retrieval of storage containers from the storage system, there will be occasions where one or more load handling devices would have to be taken out service. This could be as a result of a breakdown or malfunction of the load handling device or simply the need to service the load handling device. In both cases, access to the load handling device would be required by maintenance personnel. However, in the case where the load handling device resides in the freezer temperature area, which can be low as −30° C., this introduces another problem of the health and safety of the maintenance personnel working at such low temperatures.

Thus, there is a need for an automated storage and retrieval system for storing frozen or chilled items without the shortcomings discussed above.

### SUMMARY

One of the biggest challenges not envisaged in the art in providing an automated storage and retrieval system for storing items at freezing temperatures, which can be as low as −30° C., or chilled temperatures in the region 1° C. to 8° C., is ability to provide a comfortable working environment for personnel to work on one or more robotic load handling devices in-situ, i.e., on the grid framework structure. Traditionally, to protect personnel working at such low temperatures and to adhere to health and safety provisions personnel or operators wear personal protective equipment (PPE). The PPE tend to be thermally insulated garments including the use of gloves, which are generally thick to provide the necessary thermal insulation from the cold environment in the freezer area or chilled area. However, the use of such PPE impairs the dexterity of personnel to work on delicate and/or small components. This can be particularly problematic where personnel have to work on a robotic load handling device comprising delicate electrical circuitry and intricate mechanical components. The term “robotic load handling device” and “load handling device” are used interchangeably in the description to mean the same feature. One solution would be to take the malfunctioned robotic load handling device out of the freezer or chilled area into a more comfortable working temperature environment. For the purpose of the present invention, the comfortable working environment can be at temperatures in the region +25° C. to 4° C. Such temperatures can overlap the chilled area.

Whilst no special processes are required for the movement of the robotic load handling devices from a warmer environment to a colder environment, e.g., from an ambient area to chilled area or from a chilled area to a freezer area, the same cannot be said when going from a cold environment to a warmer environment, e.g., from the chilled area to the ambient area or from the freezer area to the chilled area or ambient area. One of the biggest problems not envisaged in the art when moving from a cold environment to a warmer environment, e.g., from the freezer area to a warmer environment, is the risk of condensation and moisture ingress. The condensation risk is greatest when moving a robotic load handling device out of the freezer area or freezer zone of the storage system, which can be as low as −30° C., to a warmer environment of the storage system, e.g. chilled area or ambient area. For example, movement between different temperature areas or zones may involve taking a robotic load handling device out of the freezer area for servicing or repair. In such a case, it is necessary that the load handling device would have to be moved to a warmer environment, in order to provide a comfortable working temperature for an operator without the need or limited use of PPE.

In some instances, the condensation risk of moving a robotic load handling device from a cold area to a warmer area may affect one or more electrical components of the robotic load handling device. For example, condensation can lead to electrical shorting and/or bad electrical contacts. Both effects can compromise the reliability of the respective circuitry and/or can even lead to the destruction of the circuitry or at least one of components of the circuitry. Furthermore, condensation will lead to corrosion effects, shortening the lifetime of the circuitry or the build-up of moisture on the robotic load handling devices.

The present invention has mitigated the above problem by providing an intermediate zone between a first temperature zone and a second temperature zone having an environment where the air in the intermediate zone is controlled to prevent condensation of the water vapour in the air on the load handling device when transitioning from the first temperature zone to the second temperature zone. For the purpose of definition of the present invention, the first temperature zone can be the chilled temperature zone which operates in the temperature range 1° C. to 8° C. or the freezer temperature zone which operates in the temperature range −30° C. to −18° C. The condensation risk exists when moving from the freezer temperature zone or the chilled temperature zone to a warmer environment. The warmer environment can be the chilled temperature zone or an ambient temperature zone which operates in the temperature range 1° C. to 8° C. or 15° C. to 25° C. respectively—the ambient temperature zone may overlap the chilled temperature zone.

More specifically, the present invention provides a multi-temperature storage system, comprising a first enclosure defining a first temperature zone, the first enclosure comprising a grid framework structure comprising a plurality of storage columns for the storage of a plurality of stacks of storage containers, a track system arranged above the plurality of storage columns for guiding one or more robotic load handling device on the grid framework structure; a second enclosure defining a second temperature zone, the second enclosure being configured to accommodate one or more load handling devices from the first enclosure; a cooling system configured to maintain the temperature of the air in the first temperature zone lower than in the second temperature zone; an environmental controlled enclosure comprising a first opening and a second opening for linking the first enclosure and the second enclosure respectively such that a load handling device can move between the first and second enclosures via the environmental controlled enclosure, the first and second openings being independently closeable by a respective first door and a second door to selectively isolate the environmental controlled enclosure from the first enclosure and/or the second enclosure, an environmental control unit configured to heat and/or dehumidify the air in the environmental controlled enclosure; an environmental control system configured to control the environmental control unit to provide an environmental condition in the environmental controlled enclosure in anticipation of opening the first door and/or the second door.

The second enclosure can provide a more comfortable working temperature environment for one or more personnel to operate. For example, the second enclosure can be a maintenance area or service station for servicing or repairing one or more robotic load handling devices recovered from the first enclosure.

Condensation takes place when the temperature of the air surrounding the load handling device is at a temperature below the dew point temperature of the air temperature. The dew point is the temperature the air needs to be cooled to (at constant pressure) in order to achieve a relative humidity (RH) of 100%. At this point, the air cannot hold more water in the gas or vapour form and result in the condensation of water vapour in the air. The indication of the dew point temperature at the different humidity points can be represented by an exemplary psychometric chart shown in FIG. 7, where the horizontal axis represents the dry bulb temperature indicative of the dew point temperature and the vertical axis represents the specific humidity or humidity ratio. Specific humidity is proportional to the relative humidity and is the ratio of water vapour mass to total moist air parcel mass. The dew point is the temperature along the 100% specific humidity curve line, i.e. the dew point temperature is determined by moving from a state point horizontally along the lines of constant specific humidity until the curved, 100% specific humidity curve is crossed. The robotic load handling device will have acclimatised to the temperature of the air in the first enclosure due to residing in the first enclosure for an extended period of time. As a result, the temperature of the robotic load handling device will be at a substantially lower temperature than the temperature of the air in the second enclosure. Thus, moving a load handling device from the first enclosure defining a first, lower, temperature zone to the second enclosure defining a second, higher, temperature zone may result in condensation of the water vapour in the air on the load handling device if the temperature of the air surrounding the load handling device is below the dew point temperature of the air in the second enclosure.

In accordance of the present invention, prior to moving the robotic load handling device from the first enclosure to the second enclosure, the load handling device is moved into an environmental controlled enclosure comprising a first opening and a second opening for linking the first enclosure and the second enclosure respectively. Thus, one or more load handling devices can safely move between the first and second enclosures via the environmental controlled enclosure. The first and second openings are independently closeable by a respective first door and a second door to selectively isolate the environmental controlled enclosure from the first enclosure and/or the second enclosure. To mitigate condensation, the multi-temperature storage system comprises an environmental control unit configured to heat and/or dehumidify the air in the environmental controlled enclosure. An environmental control system is configured to control the environmental control unit to provide an environmental condition in the environmental controlled enclosure in anticipation of opening the first door and/or the second door. For the purpose of the present invention, the environmental condition is the temperature and/or moisture content, i.e. relative humidity of the air. Preferably, the environmental control unit comprises a heating system and/or dehumidifier.

Since the dew point is the temperature the air needs to be cooled to at constant pressure (atmospheric pressure) in order to achieve a relative humidity (RH) of 100%, the variables that can be used to change the dew point is the temperature of the air or the moisture content of the air or both the temperature and moisture content of the air. The moisture content of the air can be indicated by the relative humidity or specific humidity of the air. For example, for a given total moisture content, increasing the temperature has the effect of reducing the relative humidity as the air becomes drier since warmer air can hold more moisture. Conversely, lowering the temperature increases the relative humidity as the air becomes wetter. The dew point is reached when the relative humidity reaches 100%. As a result, the dew point is reached easier at lower temperatures than at higher temperatures. Thus, by controlling the temperature and/or humidity of the air in the environmental controlled enclosure, the dew point temperature can be controlled to be below the temperature of the air surrounding the robotic load handling device entering the environmental controlled enclosure from the first enclosure. Optionally, the environmental control system comprises: a controller; a first temperature sensing means configured to measure the temperature of the air or the load handling device in the first enclosure; a second temperature sensing means configured to measure the temperature of the air or the load handling device in the environmental controlled enclosure; a humidity sensing means configured to measure the relative humidity of the air in the environmental controlled enclosure; wherein the controller is configured to: receive temperature data from the first temperature sensing means; receive temperature data from the second temperature sensing means; receive humidity data from the humidity sensing means; process the received temperature and humidity data from the second temperature and humidity sensing means to indicate a dew point within the environmental controlled enclosure; control the environmental control unit to the environmental condition such that the dew point in a given time in the environmental controlled enclosure is substantially at or less than the temperature from the first temperature sensing means.

To mitigate the risk of condensation when moving from the first enclosure to the environmental controlled enclosure, the environmental condition in the environmental controlled enclosure can be controlled such that the calculated dew point of the air in the environmental controlled enclosure is at or less than the temperature from the first temperature sensing means, i.e. less than the temperature of the air or the load handling device in the first enclosure. The controller can include control logic or circuitry for determining the dew point of the air in the environmental controlled enclosure based on the signals from the second temperature sensing means and the humidity sensing means. Calculation of the dew point can be obtained from a look-up table located in a program memory of the controller. In anticipation of opening the first door linking the first enclosure, the controller receives temperature data from the first temperature sensing means indicative of the temperature of the air or the load handling device in the first enclosure. With reference to the psychometric chart shown in FIG. 7, the dew point can be changed by either varying the moisture content of the air at a constant temperature or the temperature at a given moisture content of the air or both. In one optional aspect of the present invention, the relative humidity of the air in the environment controlled enclosure can be controlled by varying the moisture content of the air in the environment controlled enclosure at a predetermined temperature such that the calculated dew point of the air in the environmental controlled enclosure is less than the temperature of the air or the load handling device in the first enclosure. For example, according to a known dew point calculator (Magnus formula), to achieve a dew point temperature less than −18° C. at a temperature of 5° C. of the air in the environmental controlled enclosure, the relative humidity of the air in the environmental controlled enclosure would need to be around or less than 18%. Knowing that the temperature reading from the first temperature sensing means is set to a predetermined temperature, e.g. −18° C., the controller can be configured to control the environmental control unit to regulate the environmental condition, i.e. relative humidity and/or temperature, to maintain a predetermined dew point in the environmental controlled enclosure. The environmental condition can be regulated such that the calculated dew point of the air in the environmental controlled enclosure is less than the freezing temperature set in the first enclosure.

As the robotic load handling device is intended to be moved into the second enclosure, the environmental control system further comprises a third temperature sensing means configured to measure the temperature of the air or the robotic load handling device in the second enclosure. To mitigate the risk of condensation when moving the robotic load handling device into the second enclosure, the controller can be configured to control the environmental control unit to regulate the environmental condition in the environmental controlled enclosure at a temperature measured from the second temperature sensing means being substantially equal to the temperature measured from the third temperature sensing means. For example, the controller can be configured to regulate the relative humidity to maintain a predetermined relative humidity of the air in the environmental enclosure at a temperature measured from the second temperature sensing means being substantially equal to the temperature measured from the third temperature sensing means so as to maintain a dew point at or below the temperature measured from the first temperature sensing means. In other words, the environmental control unit can be controlled to regulate the environmental condition in the environmental controlled enclosure such that the dew point of the air in the environmental controlled enclosure is less than the temperature of the air in the first enclosure. To enable the robotic load handling device move into the second enclosure, the temperature of the air in the environmental controlled enclosure is substantially equal to the temperature of the air in the second enclosure.

If the moisture content of the air in the environmental controlled enclosure is too high such that the calculated dew point of the air in the environmental controlled enclosure is above the temperature measurement from the first temperature sensing means, optionally, the controller is configured to control the environmental control unit to dehumidify the air in the environmental controlled enclosure at a temperature measured from the second temperature sensing means being substantially equal to the temperature measured from the third temperature sensing means.

In this way, a robotic load handling device can move from the first enclosure into the second enclosure via the environmental controlled enclosure without the risk of condensation. This is because the dew point of the air is below the temperature reading from the first temperature sensing means by virtue of having a lower moisture content of the air in the environmental controlled enclosure. As the temperature of the air in the environmental controlled enclosure is substantially the same as the temperature reading from the third temperature sensing means (i.e. in the second enclosure) there is little risk of condensation when the robotic load handling device enters the second enclosure having a higher moisture content in the air. This allows the temperature of the air in the second enclosure to be set to a much comfortable working temperature than the temperature environmental in the first enclosure, e.g. freezer temperature.

One way to achieve this comfortable working temperature in the second enclosure is to allow the robotic load handling device to dwell in the environmental controlled enclosure at a controlled humidity until the temperature of the robotic load handling device is substantially equal to the temperature of the air in the second enclosure, e.g. the temperature of the air surrounding the load handling device is substantially equal to the temperature of the air in the environmental controlled enclosure and thus, the second enclosure. To raise the temperature of the robotic load handling device in the environment-controlled enclosure, optionally, the environmental controlled enclosure comprises a heating chamber for housing one or more robotic load handling devices. The heating chamber comprises one or more heating devices for heating the one or more robotic load handling devices housed within the heating chamber. Considering that the operating temperature of the robotic handling device in the first enclosure can be as low as −18° C. when operating in the freezer area, the heating chamber provides a second environment in the environmental controlled enclosure to accelerate the heating of the robotic load handling device to a temperature substantially equal to the temperature of the air in the second enclosure. For example, if the first enclosure is a freezer zone operating at a temperature of −18° C. and the second enclosure is operating at a temperature of 4° C. at a comfortable relative humidity of 60%, to achieve a calculated dew point of −20° C. in the environmental controlled enclosure to mitigate condensation on the robotic load handling device at 4° C., the relative humidity in the environmental controlled enclosure is calculated to be about 15%. Thus, warming the robotic load handling device in the environmental controlled enclosure to a temperature of 4° C. would mitigate the risk of condensation when moving the robotic load handling device into the second enclosure. The environmental controlled enclosure can be a closed enclosure, e.g. an airlock, to prevent the ingress of moisture into the environmental controlled enclosure.

Typically, the freezer zone operates in a temperature range of −28° C. to −18° C. and a relative humidity of up to 70% and the maintenance area operates in the region 0° C. to 5° C. and a relative humidity up to 80%. To mitigate condensation, the environmental controlled enclosure operates at a temperature in the range 0° C. to 5° C. and a relative humidity of up to 11% to give a dew point of around −27° C.

To ensure that the temperature of the robotic load handling device does not fall below the dew point temperature of the air in the second enclosure, optionally, the environmental control system further comprises a second humidity sensing means configured to measure the relative humidity of the air in the second enclosure; wherein the controller is further configured to: receive temperature and humidity data from the third temperature and second humidity sensing means respectively; process the received temperature and humidity data from the third temperature and second humidity sensing means to indicate a second dew point within the second enclosure; compare the second dew point with the temperature data from the second temperature sensing means; and if the temperature data from the second temperature sensing means is at or below the second dew point, control the environmental control unit to provide a second environmental condition in the environmental controlled enclosure such that the second dew point in a given time in the second enclosure is substantially at or below the temperature measured from the second temperature sensing means.

Thus, when moving from the environmental controlled enclosure into the second enclosure, the controller can control the environmental control unit to provide a second environmental condition in the environmental controlled enclosure to cater for the moisture content and temperature of the air in the second enclosure, i.e. determine a second dew point of the air in the second enclosure and to ensure that the temperature reading from the second temperature sensing means (temperature within the environmental controlled enclosure) is at or above the second dew point. For example, the environmental control system can be configured to control the environmental control unit to provide an environmental control condition in the environmental controlled enclosure to cater for the different temperatures and/or relative humidity of the first enclosure and the second enclosure, i.e. to dynamically control the environmental condition in the environmental controlled enclosure to cater for the environment condition (e.g. temperature and/or relative humidity) in the first enclosure and the second enclosure.

In addition to controlling the environmental control unit to provide an environmental condition in the environmental controlled enclosure such that the dew point of the air is substantially at or below the temperature from the first temperature sensing means, optionally, the controller can be configured to control the environmental control unit to provide a second environmental condition in the environmental controlled enclosure at a temperature measured from the second temperature sensing means being substantially equal to the temperature measured from the third temperature sensing means such that the temperature from the second temperature sensing means is at or above the second dew point.

Optionally, the second environmental condition is substantially equal to the environmental condition. In this way, the environmental condition in the environmental controlled enclosure can be shared between the first enclosure and the second enclosure such that the dew point of the air in the environmental controlled enclosure is at or below the temperature reading from the first temperature sensing means and the second dew point of the air in the second enclosure is below the temperature reading from the second temperature sensing means.

To ensure that the air surrounding the robotic load handling device does not become “stale” and is continuously replenished with fresh “conditioned” air in the environmental controlled enclosure, optionally, the environmental control unit comprises one or more fans for circulating air in the environmental controlled enclosure.

Optionally, the cooling system comprises a first refrigerating unit for cooling the air inside the first enclosure and a second refrigerating unit for cooling the air inside the second enclosure. The second refrigeration system ensures that the temperature of the air in the second enclosure can be set to a reasonable level in order for the environmental control unit to provide an environmental condition in the environmental controlled enclosure such that the calculated dew point temperature of the air is below the temperature of the air in the first enclosure, e.g. below −18° C. and the dew point of the air in the second enclosure is below the temperature of the air in the environmental controlled enclosure.

To enable a robotic load handling device to move along the tracks of the grid framework structure in the first enclosure to the environmental controlled enclosure, optionally, the environmentally controlled enclosure comprises a set of parallel tracks extending from the track system in the first enclosure into the environmentally controlled enclosure. Optionally, the set of parallel tracks extends into the second enclosure such that a robotic load handling device can move be from the first enclosure into the second enclosure via the environmental controlled enclosure. As there is a temperature difference between the first enclosure and the environmental controlled enclosure, this may result in a difference in the thermal expansion or contraction of the tracks between at least a portion of the set of parallel tracks residing in the first enclosure and at least a portion of the set of parallel tracks residing in the environmental controlled enclosure, which in turn, may result in relative movement between the different portions of the track elements. In a worst-case scenario, the relative movement between the different portions of the tracks may cause at least a portion of the parallel tracks to buckle. This is particularly the case where the tracks are largely composed of metal. To accommodate for the different levels of expansion and/or contraction between the different portions of the sets of parallel tracks, the set of parallel tracks comprises a first portion of parallel tracks and a second portion of parallel tracks, the first portion of parallel tracks residing in the first enclosure and the second portion of parallel tracks residing in the environmental controlled enclosure, wherein the set of parallel tracks comprises an expansion joint that interfaces or bridges the first and second portions of the parallel tracks to provide a continuous track surface extending in a longitudinal direction from the first portion of the parallel tracks to the second portion of the parallel tracks. Various expansion joints known in the art can be used to bridge the first and second portions of the parallel tracks to enable relative movement between them. WO2023046684 (Ocado Innovation Ltd), the detail of which is incorporated herein by reference, teaches an expansion joint for connecting regions of a grid structure comprising a plurality of tracks, the expansion joint comprising: a first track element and a second track element, each of the first and second track elements providing a portion of a track of the plurality of tracks, the first and second track elements being elongate. Each of the first and second track elements has an interface portion that are arranged to slide relative to each other in a longitudinal direction to provide a double track comprising two parallel track surfaces extending from the first track element to the second track element suitable for guiding two wheeled load handling devices across the expansion joint.

To allow a robotic load hand.in device to move between different temperature environments, e.g. between the freezer zone and the chilled zone, such that a robotic load handling device can be shared between the different temperature environments, optionally, the second enclosure comprises a second grid framework structure comprising a plurality of storage columns for the storage of a plurality of stacks of storage containers, a second track system arranged above the plurality of storage columns for guiding one or more robotic load handling device on the second grid framework structure, and wherein the set of parallel tracks extend from the environmental controlled enclosure into the second track system to interconnect with the second track system, i.e. the first enclosure defines a first storage and retrieval system and the second enclosure defines a second storage and retrieval system.

### DESCRIPTION OF THE DRAWINGS

Further features and aspects of the present invention will be apparent from the following detailed description of an illustrative embodiment made with reference to the drawings, in which:

FIG. 1 is an illustration of an automated storage and retrieval system according to an exemplary embodiment of the present invention.

FIG. 2 is a schematic diagram of a top down view showing a stack of bins arranged within the framework structure of FIG. 1.

FIG. 3 is a schematic diagram of a system of a known robotic load handling device operating on the grid framework structure.

FIG. 4 is a schematic perspective view of the load handling device showing the container receiving space within the body of the load handling device.

FIG. 5A-5B are schematic perspective cut away views of the load handling device of FIG. 4. FIG. 5A shows a container accommodated within a container receiving space of the load handling device and FIG. 5B shows the container receiving space of the load handling device.

FIG. 6 is a schematic perspective view of a multi-temperature storage system comprising separate enclosures defining different temperature zones representing the freezer or the chilled temperature zone and the service station, and the robotic load handling devices being able to be moved between the different temperature zones.

FIG. 7 is an illustration of an exemplary psychrometric chart showing the different humidity conditions of the different temperature zones of the storage and retrieval system.

FIG. 8 is a schematic perspective view of a multi-temperature storage system having a first enclosure defining a first temperature zone, a second enclosure defining a second temperature zone forming a service station and an environmental controlled enclosure intermediate the first and second enclosures to condition the robotic load handling devices when moving between the first enclosure and the second enclosure.

FIG. 9 is a schematic perspective view of an example of the multi-temperature storage system showing the grid framework structure in the first enclosure, the service station and the environmental controlled enclosure providing a passageway for a robotic load handling device to transition between the first enclosure and the service station.

FIG. 10 is a schematic perspective view of a storage and retrieval system shown in FIG. 8 where the environmental controlled enclosure additionally comprises a heating chamber for heating one or more robotic load handling devices in the environmental controlled enclosure.

FIG. 11 is a schematic perspective view of an example of the storage and retrieval system showing the grid framework structure in the first enclosure, the service station and the environmental controlled enclosure providing a passageway for a robotic load handling device to transition between the first enclosure and the service station, the environmental controlled enclosure comprising a heating chamber for heating one or more robotic load handling devices in the environmental controlled enclosure.

FIG. 12 is a block diagram showing the operational components of the environmental control system to control the environmental condition in the environmental controlled enclosure according to an exemplary embodiment of the present invention.

FIG. 13 is a schematic perspective view of a multi-temperature storage system comprising a first storage and retrieval system and a second storage and retrieval system, and an environmental controlled enclosure for conditioning a robotic load handling device to be able to be moved between the first and second storage and retrieval systems to mitigate the risk of condensation.

FIG. 14A is an isometric view of the multi-temperature storage system at the interface between the first enclosure and the service station; FIG. 14B is an enlarged view of the region of the interface circled by the dashed line.

FIG. 15 is a perspective view of a pair of tracks at the interface between the first enclosure and the environmental controlled enclosure comprising an expansion joint bridging their respective track elements to provide a continuous track surface extending from the first enclosure to the environmental controlled enclosure.

### DETAILED DESCRIPTION

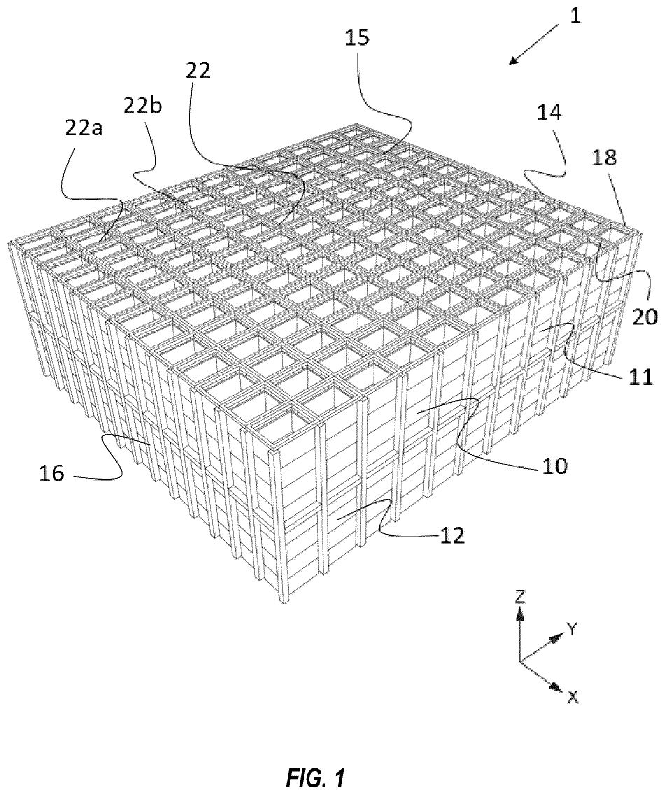

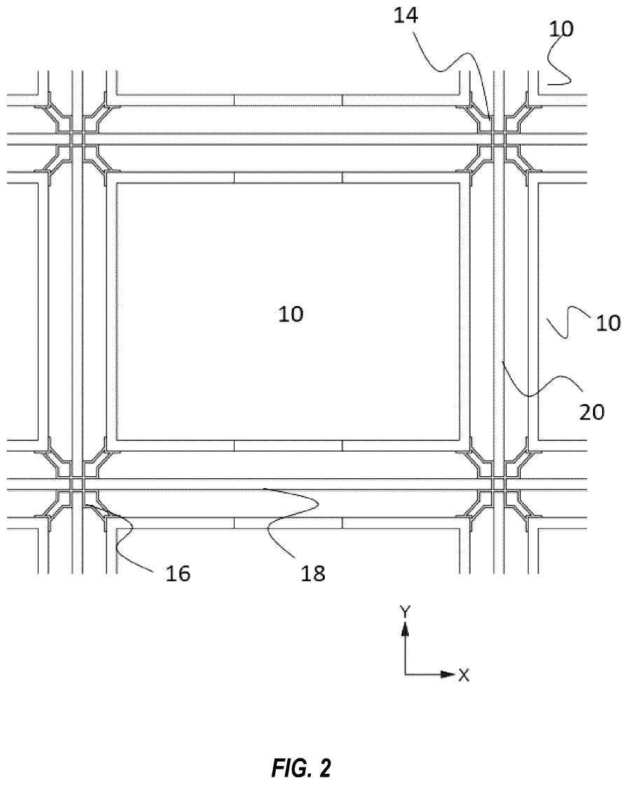

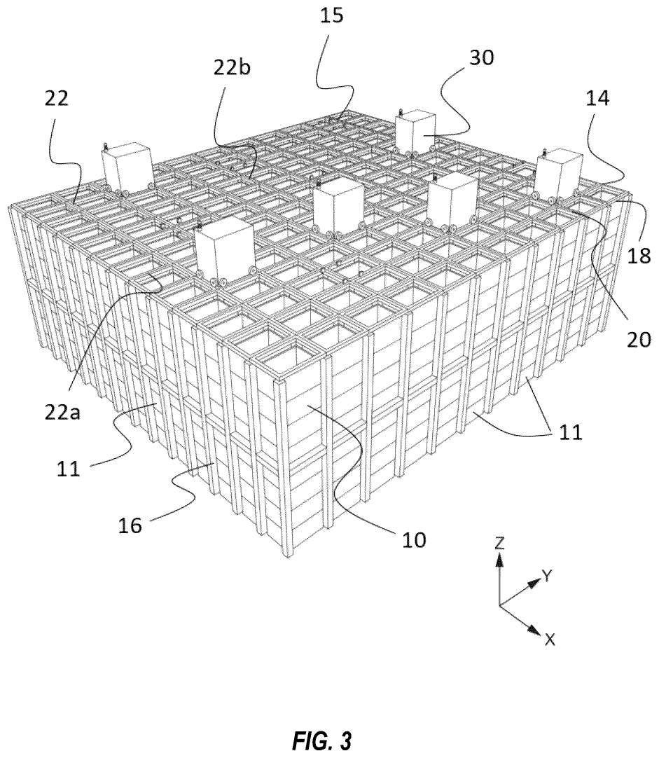

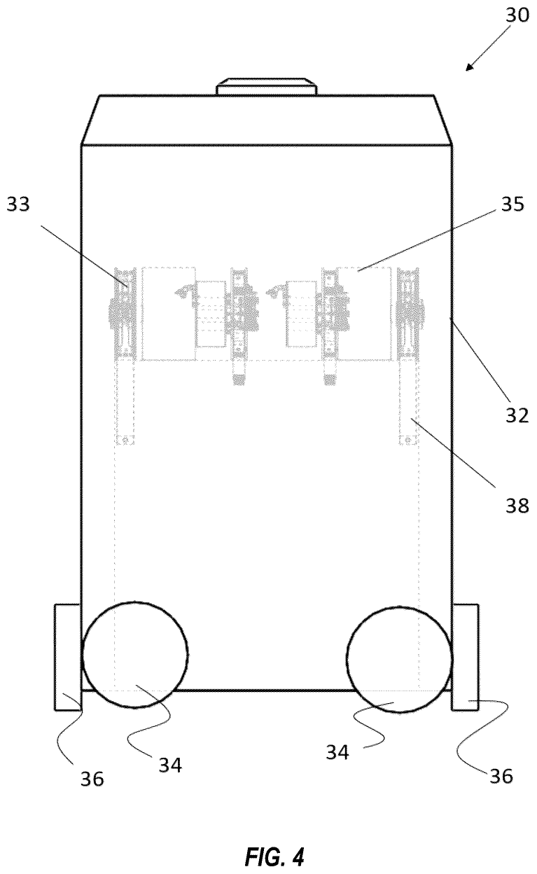

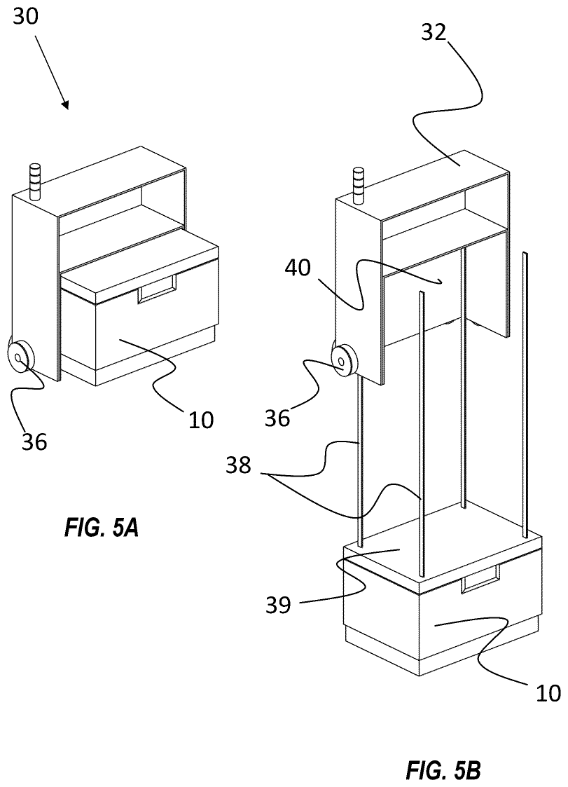

It is against the known features of the storage system such as the grid framework structure and the load handling device described above with reference to FIGS. 1-5B the present invention has been devised. Typically, in any given time, there are a large number of robotic load handling devices operational on the track system. The robotic load handling devices are assigned to be operational continuously on the track system for more than 18 hours periodically visiting a charging station to charge the on-board battery during this time. However, one or more of these robotic load handling devices can experience problems from time to time and require repair or other intervention in order to return to useful service.

In order to retrieve one or more robotic load handling devices operable on the grid framework structure for servicing or repair, a service station or maintenance area is typically positioned adjacent the grid framework structure. The grid framework structure provides a storage area for one or more stacks of storage containers in one or more storage columns as discussed above. To enable a robotic load handling device to be moved from the grid framework structure into the maintenance area, a set of parallel tracks of the track system extends into the maintenance area. Alternatively, the maintenance area can comprise a second track system for moving a robotic load handing device into the maintenance area. The track system of the grid framework structure interconnects the second track system via a set of parallel tracks so as to enable one or more robotic load handling device operable on the grid framework structure to be moved into the maintenance area and vice versa.

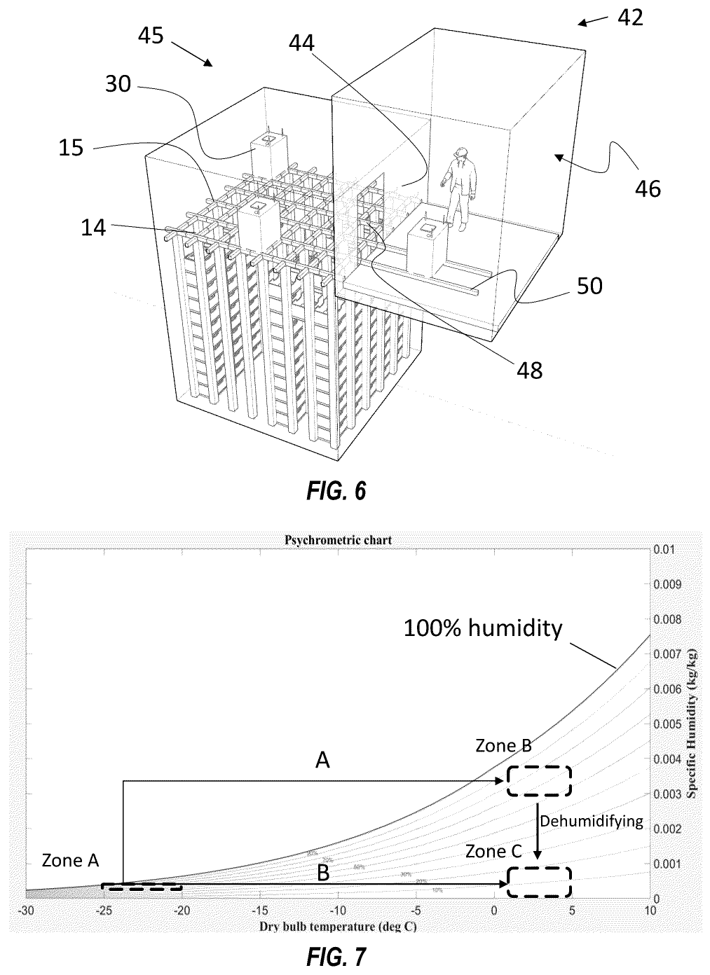

FIG. 6 is a perspective view of a storage and retrieval system 42 currently practiced in the art to move one or more robotic load handling devices 30 that has malfunctioned or is required for servicing from a storage area 45 into a maintenance area 46. At least one barrier 44 separates the storage area 45 comprising the grid framework structure 14 from the maintenance area 46 and comprises one or more portals 48 that open through the at least one barrier 44. A set of parallel tracks 50 extends through the opening of a respective portal 48. The set of parallel tracks 50 provides a continuous track surface extending from the storage area 45 into the maintenance area 46. The track surface can either provide a single track surface to allow a single load handling device to travel on the track between the storage area 45 and the maintenance area 46 or a double track surface so as to allow two load handling devices to pass each other on the same track between the storage area 45 and the maintenance area 46. In the case where the elongated element is profiled to provide a single track, the track comprises opposing lips (one lip on one side of the track and another lip at the other side of the track) along the length of the track to guide or constrain each wheel from lateral movement on the track. In the case where the profile of the elongated element is a double track, the track comprise two pairs of lips along the length of the track to allow the wheels of adjacent load handling devices to pass each other in both directions on the same track. To provide two pairs of lips, the track typically comprises a central ridge or lip and a lip either side of the central ridge. Details of the different types of track is discussed in WO2022/034191 (Ocado Innovation Limited), the details of which are incorporated herein by reference.

The opening in the portals 48 are sized to allow one or more of the robotic load handling devices to be moved into the maintenance area 46 through the at least one barrier 44. In some designs, a door (not shown) is present for closing and opening the opening of the portal 48. To ensure that the interconnection of the tracks between the track system 15 of the grid framework structure 14 and the maintenance area 46 is level, the maintenance area 46 is usually positioned on a mezzanine supported by vertical beams adjacent the grid framework structure as shown in FIG. 6. Thus, a malfunctioned robotic load handling device on the track system 15 of the grid framework structure can simply be pushed or towed along the tracks from the storage area of the storage and retrieval system into the maintenance area.

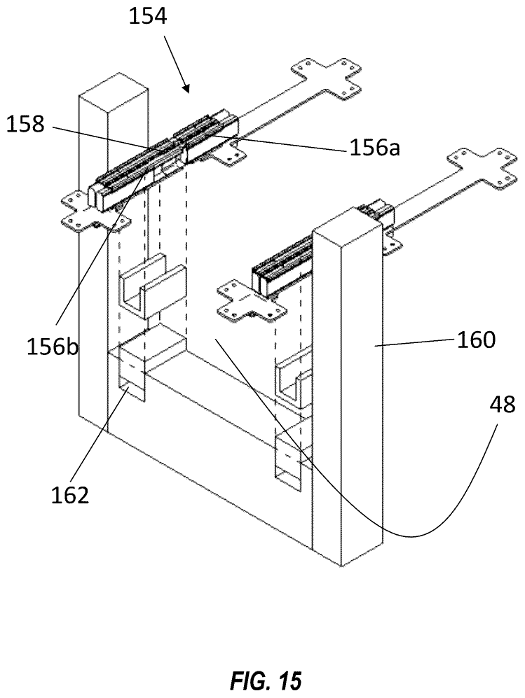

Typically, such a set up shown in FIG. 6 works well where the temperature of the air in the storage area 45 comprising the grid framework structure is substantially the same as the temperature of the maintenance area 46. Subject to seasonal effects, typically, the temperature of the air in an ambient region or zone covers a temperature range of 15° C. to 32° C. and a relatively humidity range of 23% to 65%. To store goods in a chilled or frozen environmental zone, the grid framework structure is usually housed in a separate enclosure where the walls of the enclosure are formed from thermally insulating material, e.g. foam insulation, to mitigate the transfer of heat into the enclosure. A door for closing and opening the portal prevents the ingress of warm air from the maintenance area into the chilled or frozen storage area. For the purpose of definition, the storage area 45 housing the grid framework structure can be defined as a first enclosure and the maintenance area 46 can be defined as a second enclosure. Optionally, the closable door is configured to provide a fluid tight seal between the storage area 45 and the maintenance area 46 when in a closed position, e.g. the use of rubber seals around the periphery of the door. In the example shown in FIG. 15, the portal can optionally comprise an insulating door frame 160 surrounding the door to prevent the ingress of warmer air into the storage area 45 and the displacement of cold air into the maintenance area 46 around the periphery of the door. Whilst the ingress of warmer air into the storage area 45 will have little impact on the temperature of the air in the storage area 45 due to the volume of air in the storage area being much larger than the volume of air in the maintenance area 46, the ingress of colder air into the warmer maintenance area may result in condensation of water vapor in the maintenance area if the temperature of the colder air is below the dew point temperature of the air in the maintenance area. This is particularly the case where the air in the storage area 45 is at freezing temperature which can range between −18° C. to −30° C. Moisture will have a tendency to condense around the closable door, particularly around the door frame. Regular opening of the door may result in the condensed water freezing, particularly around the door and subsequently, preventing the door from properly closing. The insulating door frame 160 shown in FIG. 15 not only insulates the storage area 45 from the maintenance area but also helps to prevent the ingress of colder air into the maintenance area 46.

A cooling system comprising a refrigeration unit widely known in the art comprising a refrigerant circuit and a compressor maintains the temperature of the air in the chilled or frozen storage area. One or more robotic load handling devices operable on the grid framework structure in the storage area 45 is able to retrieve one or more storage containers from a stack in a storage column of the grid framework structure 14 and transport the storage container to a pick station via a drop-off port in the track system 15. Should anyone of the robotic load handling devices malfunction, there is a requirement to take the malfunctioned robotic load handling device out of service into the maintenance area 46. However, where the temperature and/or the moisture content of the air in the maintenance area 46 is higher than the air in the storage area 45, this introduces a condensation risk whenever a malfunctioned robotic load handling device is moved into the maintenance area at a much lower temperature.

The risk of condensation can be explained by reference to the psychometric chart shown in FIG. 7 where the X-axis of the psychometric chart representative of the dry-bulb temperature provides an indication of the dew point temperature of the air and the Y-axis of the psychometric is indicative of the specific humidity or humidity ratio. Condensation takes place when the temperature of the air is at or below the dew point temperature. It is the temperature the air needs to be cooled to (at constant pressure) in order to achieve a relative humidity (RH) of 100%. This is shown in the psychometric chart by crossing the 100% humidity curve. At this point, the air cannot hold more water in the gas form and condenses to form a liquid. Moving a robotic load handling device that has acclimatized in a cold environment, i.e. the storage area 45, such as the freezer region or chilled region, to a warmer environment, i.e. the maintenance area 46, such as the chilled region or ambient region respectively, the robotic load handling device and thus, the air surrounding the robotic load handling device would still be at the temperature of the air in the cold environmental. The environmental condition of the air in the maintenance area 46, i.e. temperature and relative humidity, may be such that the dew point temperature of the air in the maintenance area 46 is above the temperature of the air surrounding the robotic load handling device (more specifically, the temperature of the robotic load handling device) entering the second enclosure from the first enclosure. As the temperature of the air surrounding the robotic load handling device is below the dew point temperature of the air in the second enclosure, the moisture capacity of the air is reduced resulting in condensation of water vapor on the robotic load handling device or one or more components of the robotic load handling device. Components of the robotic load handling devices composed of high thermal conductive material such as metal components would be susceptible to condensation. The dew point temperature of the air surrounding the robotic load handling device may be determined based on the temperature measured by a temperature sensing means and the relative humidity of the air measured by a relative humidity sensor. The temperature of the robotic load handling device is not limited to the body of the robotic load handling and can include any of the components of the load handling device that is exposed to the air, e.g. motors, wheels, electrical component, etc. The temperature sensing means include but is not limited to the use of a thermocouple, infrared temperature sensor, thermal camera, etc. The relative humidity sensing means include but is not limited to Capacitive Humidity Sensors, Electrical Conductivity (or Resistive) Humidity Sensors or Thermal Conductivity Humidity Sensors.

The environmental condition of the air when moving from the first “cold” enclosure to a second “warmer” enclosure can be exemplified by moving from Zone A to Zone B in the psychometric chart shown in FIG. 7. Zone A represents the environmental condition of the air in the freezer region or zone and Zone B represents the environmental condition of the air in the chilled region or zone. Typically, the environmental condition in the freezer zone covers a temperature in the range −30° C. to −18° C. and a relative humidity in the range 80% to 90% resulting in a calculated dew point temperature in the range −25° C. to −20° C. and Zone B covers an environmental condition in the chilled zone covers a temperature in the range 1° C. to 5° C. and a relative humidity in the range 70% to 85% resulting in a calculated dew point temperature in the range −4° C. to 3° C. In moving the robotic load handling device from Zone A representative of the freezer zone to Zone B representative of the chilled zone, the moisture capacity of the air surrounding the robotic load handling device is reached as the 100% humidity curve is crossed resulting condensation of the water vapor in the air into liquid form. This is shown in FIG. 7 by the arrow A crossing the 100% humidity curve.

One option to mitigate the risk of condensation is to dehumidify the air in the warmer region, i.e. lower the moisture content of the air, such that the calculated dew point of the air is lower than the temperature of the air surrounding the load handling device. To achieve a lower dew point in the warmer region, e.g. −26° C., the moisture content of the air at an elevated temperature of say 4° C., according to the psychometric chart in FIG. 7, must be lowered to about 10% relative humidity (see Zone C). However, the recommended safe levels of humidity in a workplace environment should be around 40% to 70%. Prolonged exposure to an ambient environment having a relative humidity of less than 40% would be considered unsafe and fall foul of recommended health and safety guidelines.

In accordance of the present invention, the robotic load handling device is placed in an intermediate zone prior to being transported to the warmer enclosure where the environmental condition of the air in the intermediate zone is controlled to mitigate the risk of condensation. For the purpose of the present invention, the environmental condition can be the temperature and/or relative humidity of the air. The temperature and/or relative humidity of the air can be controlled by an environmental control unit comprising a heating system and/or a dehumidifying system. One way to control the environmental condition of the intermediate zone to mitigate the risk of condensation when moving from a cold environment to a warmer environment is to lower the relative humidity of the air in the warmer environment to a such a level such that the calculated dew point of the air is below the temperature of the air surrounding the robotic load handling device. The intermediate zone can be considered as a transitional or intermediary area where there will be no prolonged exposure of personnel in this area so mitigating the risk to health.

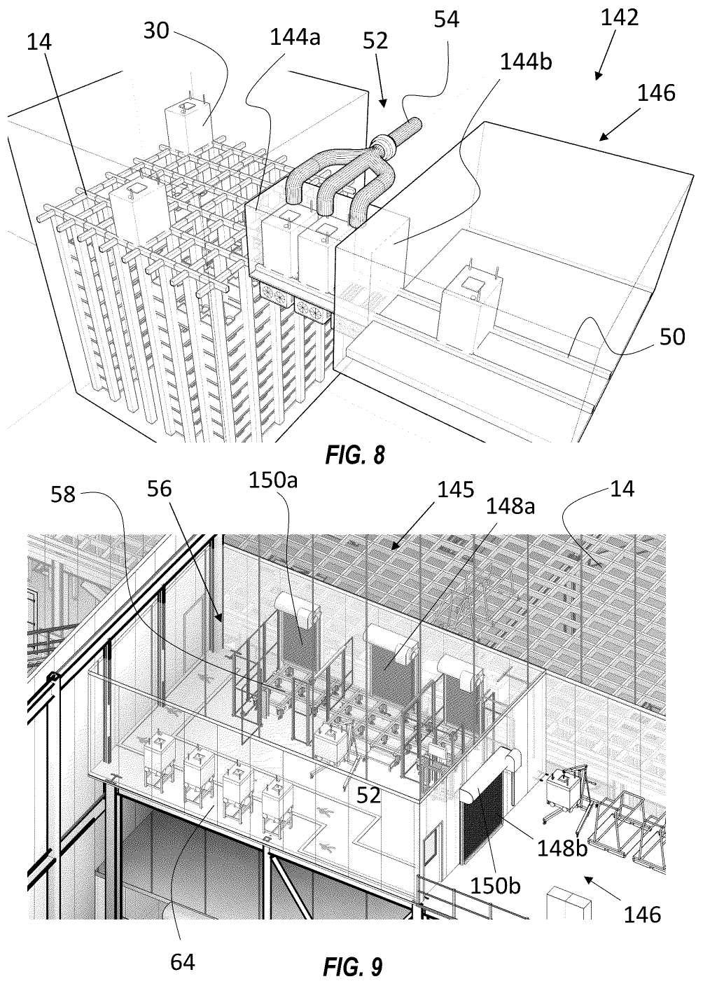

In comparison to lowering the humidity of the maintenance area making it uncomfortable for personnel to work, the intermediate zone provides an area for conditioning the robotic load handling device to mitigate the risk of condensation prior to being moved into the maintenance area. For the purpose of definition of the present invention, the intermediate zone can be defined as an environmental controlled enclosure 52. Thus, a robotic load handling device is moved from the first enclosure 145 to the second enclosure 146 via the environmental controlled enclosure 52. The first, second and environmental controlled enclosures can be adjacent to each other so that adjacent enclosures share a wall or alternatively, they can be separate enclosures with an enclosed passageway or tunnel between adjacent enclosures. In the particular embodiment of the present invention shown in FIGS. 8 to 11 and 13, the enclosures are adjacent each other so that adjacent enclosures share a wall. To maintain the temperature of the air in the first, second and environmental controlled enclosures, at least one wall of the enclosure is formed from thermally insulating material, e.g. thermally insulating foam or blanket.

FIG. 8 is a perspective view of a multi-temperature storage system 142 comprising the environmental controlled enclosure 52 for transitioning a robotic load handling device from the first enclosure 145 to the second enclosure 146 via the environmental controlled enclosure 52 according to an exemplary embodiment of the present invention. The environmental controlled enclosure 52 can be an area where there will be little exposure to personnel and most of the activity of servicing or repairing the robotic load handling device will be carried out in the second enclosure 146 comprising the maintenance area.

To create an environment where the air can be conditioned when moving a robotic load handling device from the first enclosure 145 to the second enclosure 146, the environmental controlled enclosure 52 is isolated from the first enclosure 145 and the second enclosure 146. A first wall 144a separate the environmental controlled enclosure 52 from the first enclosure 145 and a second wall 144b separates the environmental controlled enclosure 52 from the second enclosure 146. The environmental controlled enclosure 52 is shown in FIG. 9 as a separate room 56 adjacent the first enclosure 145 comprising the grid framework structure 14 and the second enclosure 146 comprising the maintenance area. The room 56 could be an airtight or fluid tight room to prevent the ingress of moist air from the first enclosure 145 and/or the second enclosure 146. To enable a robotic load handling device to travel between the first enclosure 145 and the environmental controlled enclosure 52 and between the environmental controlled enclosure 52 and the second enclosure 146, the first wall 144a and second wall 144b comprise first opening 148a and second opening 148b respectively. To isolate the first enclosure 145 from the environmental controlled enclosure 52 and the second enclosure 146 from the environmental controlled enclosure 52, the first and second openings 148a, 148b comprise a first door 150a and a second door 150b respectively. The first door 150a and second door 150b are closeable to respectively isolate the environmental controlled enclosure 52 from the first enclosure 145 and the environmental controlled enclosure 52 from the second enclosure 146. Various doors known in the art to thermally isolate/seal one enclosure from another enclosure can be used in the present invention. These include but is not limited to roller doors, the use of silica aerogel insulating material in the doors, thermally insulated curtains, e.g. thermal strip curtains, etc. In absence of any physical door, an air curtain (also known as an air door or invisible door) which take air from within the enclosure, and emit a constant stream of air which travels downwards from the air curtain unit to the track system can be used to thermally isolate one enclosure from another enclosure. In the particular embodiment of the present invention shown in FIG. 9, the first door 150a and/or second door 150b are shown as a roller door.

The first opening 148a and second opening 148b are independently closable by the first door 150a and second door 150b, respectively, to selectively isolate the environmental controlled enclosure 52 from the first enclosure 145 and the second enclosure 146. Thus, for a robotic load handling device to be moved into the second enclosure from the first enclosure, the robotic load handling device will have to travel through the environmental controlled enclosure. In the case, where the first enclosure 145 defines the freezer zone and the second enclosure 146 defines the chilled zone or higher temperature zone (maintenance area), the pressure difference between the second enclosure and the first enclosure results in a natural convention of warm air moving into the first enclosure. As the moisture content of the air in the second enclosure 146 is higher than in the first enclosure 145 such movement of warm air into the first enclosure 145 may result in the build-up of ice in the first enclosure particularly at the entrance of the first enclosure, i.e. near the first opening 148a, Thus, when opening the first door 150a linking the first enclosure 145 to the environmental controlled enclosure 52, the second door 150b is kept closed to prevent the natural flow of warm air from the second enclosure 146 into the first enclosure 145. Likewise, when opening the second door 150b linking the second enclosure 146, the first door 150a is kept closed, i.e. independently closable. Both the first door 150a and second door 150b can be configured to provide a fluid tight seal between the environmental controlled enclosure 52 and the respective first enclosure and second enclosure, e.g. rubber seals. When one or more load handling devices are being conditioned in the environmental controlled enclosure, both the first and second doors are closed to provide a containment or sealed environment in the environmental controlled enclosure. Also shown in FIG. 9, is a second grid framework structure 58, albeit a smaller grid framework structure, in the environmental controlled enclosure 52 for receiving the robotic load handling device from the first enclosure 145. The second grid framework structure 58 comprises a second track system that suitably interconnects with the track system of the grid framework structure 14 in the first enclosure 145. One or more cranes or lifting mechanisms can be used in the environmental controlled enclosure 52 to physically lift a robotic load handling device clear of the second grid framework structure 58 in preparation to be moved into the second enclosure 146.

As shown in FIG. 8, the environmental condition, i.e. temperature and/or humidity, of the air in the environmental controlled enclosure 52 is conditioned by the environmental control unit 54 so as to provide a more comfortable working environment in the second enclosure 146 when a robotic load handling device is moved into the second enclosure but yet prevent condensation when the robotic load handling device is moved into the environmental controlled enclosure from the first enclosure 145. In one exemplary embodiment of the present invention, this is achieved by lowering the relative humidity of the air in the environmental controlled enclosure 52 at a temperature substantially equal to the temperature of the air in the second enclosure 146. The temperature of the environmental controlled enclosure can be regulated to the temperature of the air in the second enclosure. The temperature of the air in the second enclosure can be set to a more comfortable temperature than the freezer temperature in the first enclosure.

The relative humidity is lowered to the extent that the dew point temperature of the air in the environmental controlled enclosure is below the temperature of a robotic load handling device entering from the first enclosure. The environmental control unit 54 comprises a heating system for regulating the temperature of the air in the environmental controlled enclosure and a dehumidifying system for regulating the moisture content, i.e. relative humidity, of the air in the environmental controlled enclosure. Whilst from first principles, the temperature of the robotic load handling device, more specifically the air surrounding the load handling device in the environmental controlled enclosure when entering from the first enclosure, should be considered in determining the required dew point temperature of the air in the environmental controlled enclosure, the temperature of the air in the first enclosure will be considered as a first approximation to the temperature of the robotic load handling device. This is because the change in temperature of the robotic load handling device when initially moving from the first enclosure to a ‘warmer’ environmental controlled enclosure is small since the robotic load handling device would have acclimatized to the temperature in the first enclosure and will have negligible impact on the determination of the required dew point of the air in the environmental controlled enclosure. In fact, the prudent approach would be to consider the lowest temperature that the robotic load handling device would reach when entering from the first enclosure. As the robotic load handling device permanently resides in the first enclosure 145, the temperature of the air in the first enclosure 145 would be considered to be an accurate representation of the temperature of the robotic load handling device when entering the environmental controlled enclosure from the first enclosure.

The temperatures of the air in the first enclosure 145, the environmental controlled enclosure 52 and the second enclosure 146 are measured by a first temperature sensing means, a second temperature sensing means and a third temperature sensing means respectively. As discussed above, each or anyone of the first, second and third temperature sensing means can be a temperature sensing means commonly known in the art configured to measure temperatures as low as −30° C. Such temperature sensing means include but is not limited to thermocouple, thermistor type, infrared sensors etc. For example, the temperature of the load handling device can be measured by an infrared temperature sensor focusing an infrared energy beam onto the surface of the robotic load handling device. For the purpose of explanation of the present invention, the temperature of the air in the first enclosure can be considered to a first approximation as the temperature of the robotic load handling device when initially entering the environmental controlled enclosure. The present invention is not limited to the temperature of the air being the temperature of the robotic load handling device and can be the actual temperature of the robotic load handling device or any components of the robotic load handling device thereof that is susceptible to condensation, e.g. motor, lifting mechanism etc.

Where the temperature of the air in the first enclosure 145 is controlled at −25° C. to provide the freezer zone and the temperature of the air in the second enclosure 146 is controlled at 4° C. at a comfortable relative humidity, e.g. 60%, to provide a more comfortable working environmental, the environmental condition in the environmental controlled enclosure 52 is controlled such that the calculated dew point temperature of the air in the environmental controlled enclosure 52 is below the temperature of the air in the first enclosure 145. This is achieved by lowering the moisture content or relative humidity of the air in the environmental controlled enclosure at a temperature equivalent to the temperature of the air in the second enclosure to an extent that the calculated dew point of the air in the environmental controlled enclosure is below the temperature of the air in the first enclosure. In the above example, to achieve an environmental condition at 4° C. having a dew point below the temperature of −25° C., the relative humidity of the air should be less than 10%. Based on these temperature and humidity values, the calculated dew point is about −26° C. Ideally, the temperature of the air in the environmental controlled enclosure is tightly regulated such that the moisture content and thus, relative humidity, of the air in the environmental controlled enclosure does not need to be lowered to extreme levels to make the environment in the environmental controlled enclosure too hostile. For example, raising the temperature of the air in the environmental controlled enclosure above 4° C. would mean that the moisture content of the air would need to be lowered further to achieve a dew point of −26° C. For example, to obtain a dew point of −26° C. at 10° C., the relative humidity would have to be lowered to below 5% which is not only a too hostile environment but would be difficult to attain. Whilst not as low as the temperature of the air in the first enclosure, optionally, the cooling system comprises a second refrigeration unit for cooling the air in the second enclosure; the first refrigeration unit being the refrigeration unit discussed above for cooling the air in the first enclosure. For example, the second refrigeration unit cools the air in the second enclosure to achieve a temperature of about 4° C.

The effects of changing the environmental condition in the environmental controlled enclosure to cater for the different temperatures of the first and second enclosures is exemplified by Zone C in the psychrometric chart shown in FIG. 7. It is clearly apparent from the psychrometric chart that lowering the moisture content in the environmental controlled enclosure at elevated temperatures, in this case at around 1° C. to 5° C., mitigates the risk of condensation when approaching Zone C from Zone A as demonstrated by arrow B rather than approaching Zone B from Zone A as demonstrated by arrow A. In the latter case, condensation results as the 100% relative humidity curve indicative of the dew point temperature is crossed.

Lowering of the moisture content of environmental controlled enclosure is achieved by a dehumidifier system configured to collect air from the environmental controlled enclosure. In the particular embodiment of the present invention shown in FIGS. 8, 10 and 12, the dehumidifier system comprises a dehumidifier and one or more ducting 62 to draw the air from the environmental controlled enclosure. The dehumidifier may be any suitable type of dehumidifier for working at low temperatures (e.g. below 0 degrees), such as a desiccant dehumidifier or condensing type dehumidifier. Desiccant dehumidifiers typically operate by passing a humid process air stream through a desiccant material (e.g. silica gel) which absorbs moisture from the process air stream passing through it. To regenerate the desiccant material (i.e. remove the absorbed moisture), a regeneration air stream is heated and passed through the desiccant material such that the absorbed moisture is drawn into the regeneration air stream and is then vented, e.g. to the outside of a building. To allow the desiccant dehumidifier to operate continuously, the desiccant material is typically contained in a rotating wheel such that a portion of the wheel is passed through the process air stream and another portion of the wheel is passed through the regeneration air stream. In the case where a desiccant dehumidifier is used in the dehumidifier system, the regeneration air stream may originate from warmer areas of the multi-temperature storage system, e.g. room temperature areas, to improve energy efficiency. The dehumidifier system or the dehumidifier itself may optionally comprise a cooling unit for cooling down the process air (before or after the drying process) because the drying process within a desiccant dehumidifier typically results in heat being transferred into the process air steam, which may be undesirable given that the dried air is to be expelled into the environmental controlled enclosure.

Moving the robotic load handling device 30 too early into the second enclosure 146 once entered into the environmental controlled enclosure 52 from the first enclosure 145 may risk condensation due to the temperature lag between the robotic load handling device still being at the temperature of the air in the first enclosure 145 and the temperature of the air in the environmental controlled enclosure 52. To mitigate the risk of condensation when moving the robotic load handling device 30 into the second enclosure 146, the robotic load handling device is allowed to dwell in the environmental controlled enclosure 52 until the temperature of the robotic load handling device increases to approximately the temperature of the air in the environmental controlled enclosure, e.g. in this case 4° C. The temperature of the air in the environmental controlled enclosure 52 is regulated to being approximately at the same temperature of the air in the second enclosure 146. At this temperature, there is little risk that the robotic load handling device would suffer condensation when entering the second enclosure since the temperature of the robotic load handling device is approximately at the same temperature of the air in the second enclosure and therefore, would be above the dew point of the air in the second enclosure. This would be the case for a broad range of relative humidity values, e.g. up to 100% relative humidity.

As the environmental condition, i.e. temperature and humidity, in the second enclosure 146 is at a comfortable working environmental, e.g. 60%, the calculated dew point of the air in the second enclosure would be below the temperature of the robotic load handling device when the robotic load handling device enters the second enclosure from the environmental controlled enclosure. For example, where the environmental condition of the air in the second enclosure is set at 4° C. and a comfortable 60% relative humidity, this equates to a calculated dew point of −3° C. far below the temperature of the robotic load handling device. In fact, there is some play or leeway in the temperature of the robotic load handling device when entering the second enclosure 146 from the environmental controlled enclosure 52. For example, one or more components of the robotic load handling device may not necessarily be at 4° C. and be close to 0° C., which is still above the dew point of the air in the second enclosure. Equally, there is some play in the temperature of the air in the second enclosure being higher than 4° C. to mitigate the risk of condensation when the robotic load handling device enters the second enclosure and this largely depends on the moisture content, i.e. relative humidity, of the air in the second enclosure.

In the particular embodiment of the present invention shown in FIG. 9, the environmental controlled enclosure comprises a parking area 64 for holding the robotic load handling devices when received from the first enclosure 145 until the temperature of the robotic load handling device approaches the temperature of the air in the second enclosure. A plurality of the robotic load handling devices can be held in a queue in the parking area 64 whilst waiting for their respective temperatures to approach the temperature of the air in the second enclosure 146.

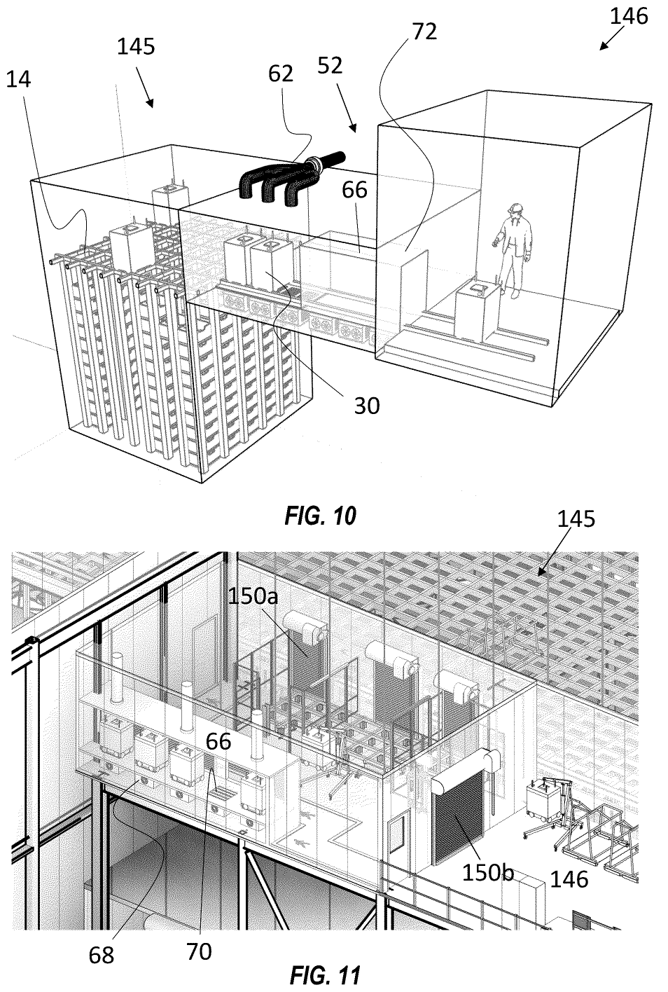

To accelerate the heating of the robotic load handling device in the environmental controlled enclosure 52, optionally, the environmental controlled enclosure 52 can comprise one or more heating chambers 66 housed within the environmental controlled enclosure 52 as shown in FIGS. 10 and 11. The heating chamber 66 can be an enclosed area within the environmental controlled enclosure 52 for housing one or more robotic load handling devices and comprises a heating system 68 for heating the robotic load handling device. In the particular embodiment shown in FIG. 11, the heating system comprises a heating device (e.g. an electrical resistance heater), one or more blowers for passing air over the heating device to elevate the temperature of the air and one or more vents 70 for directing the warm air onto the robotic load handling device. In the particular embodiment shown in FIGS. 10 and 11, the one or more vents 70 are shown integrated into the floor of the environmental controlled enclosure 52 such that the robotic load handling device is heated from below the robotic load handling device. Moist warm air generated during the heating process can be drawn into the dehumidifier via the ducting 62 as shown in FIG. 10 to regulate the relative humidity of the air in the environmental controlled enclosure. The heating chamber can be configured as a heating tunnel 72 having an opening at the entrance of the tunnel and an opening at the exit of the tunnel as shown in FIG. 10 to expedite the heating of the robotic load handling device as it travels through the heating tunnel 72. One or more robotic load handling devices are heated as they move through the heating tunnel 72 such that the temperature of the robotic load handling device is at a higher temperature when exiting the tunnel than when entering the heating tunnel. In the particular embodiment of the present invention shown in FIG. 10, the exit of the tunnel is adjacent to the second opening 148b of the environmental controlled enclosure such that a robotic load handling device exits into the second enclosure from the heating tunnel 72. The set of parallel tracks 50 extending from the first enclosure 145 into the environmental controlled enclosure 52 can continue to extend into the tunnel and the second enclosure 146 as shown in FIG. 10. The set of parallel tracks can provide a single track surface or a double track surface discussed above. Thus, a robotic load handling device can simply be moved along the set of parallel tracks 50 into the second enclosure 146 from the first enclosure 145 via the environmental controlled enclosure 52. This removes the need to lift or hoist the robotic load handling device from the second grid framework structure 58 to be either placed in the heating chamber or placed in the parking area 64 as shown in FIG. 9. Like the parking area, a plurality of robotic load handling devices can be queued in the tunnel as they emerge from the tunnel into the second enclosure.

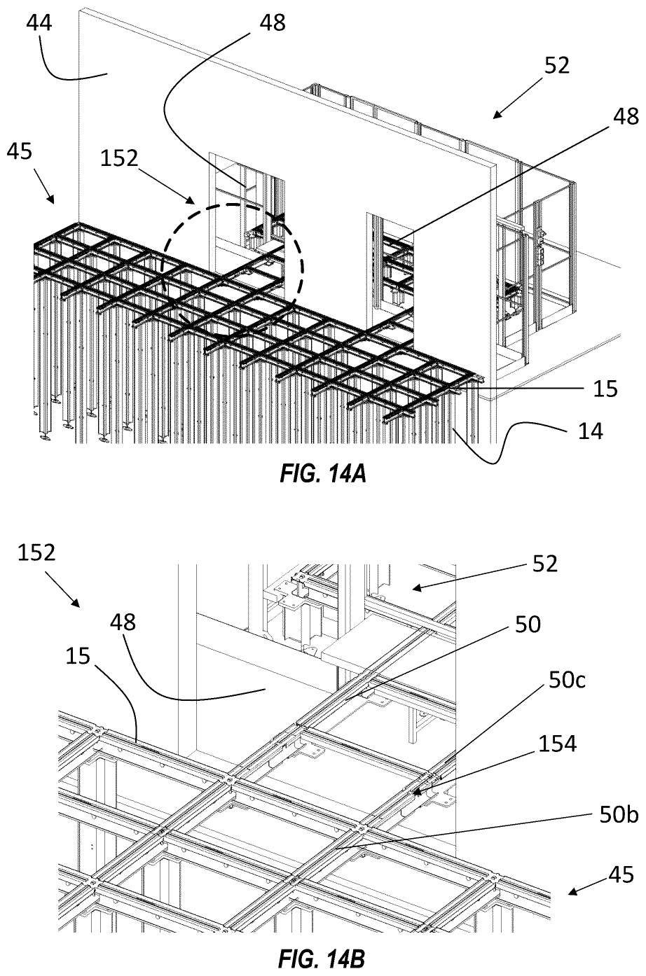

As the storage area 45 is at a much lower temperature (e.g. freezing temperature) than the environmental controlled enclosure 52, there is the risk that there will be relative movement as a result of the different levels of thermal expansion and/or contraction of the set of parallel tracks in the first enclosure and the environmental controlled enclosure 52. In a worst-case scenario, the relative movement may result in buckling of the track elements where the tracks meet at the junction or interface 152 between the storage area 45 and the environmental controlled enclosure 52 resulting in the load handling device derailing when moving from the storage area 45 to the environmental controlled enclosure. To allow movement of the track elements in a longitudinal direction of the parallel tracks between the storage area 45 and the environmental controlled enclosure 52, the set of parallel tracks at the interface between the storage area 45 and the environmental controlled enclosure 52 optionally, comprises an expansion joint or bridging element 154 (see FIGS. 14A-14B). For ease of explanation of the expansion joint 154, the portion of the set of parallel tracks 50 residing in the storage area 45 is termed a first portion of parallel tracks 50b and the portion of the set of parallel tracks 50 residing in the environmental controlled enclosure 52 is termed a second portion 50c of parallel tracks. The expansion joint 154 bridges the first and second portion of parallel tracks. The expansion joint 154 is configured to allow relative movement in a longitudinal direction of the parallel tracks between the first and second portions of parallel tracks so as to accommodate expansion or contraction of different portions of the parallel tracks extending between the different temperature enclosures. In the example of the junction 152 shown in FIG. 14A and the enlarged view of the junction 152 shown in FIG. 14(b), the set of parallel tracks 50 extending between the storage area and the environmental controlled enclosure comprises a pair of tracks, each of the pair of tracks comprises an expansion joint at the interface between the storage area and the environmental controlled enclosure. Thus, the different levels of thermal expansion and/or contraction of the track elements in each of the pair of the tracks is accommodated by their respective expansion joints to provide a continuous track surface extending in a longitudinal direction of the parallel sets of tracks.

The example of the expansion joint shown in FIG. 15 comprises a first track element 156a and a second track element 156b, each of the first and second track elements 156 a, b providing a portion of a track of the set of parallel tracks. The first track element 156 and second track element 156b are elongate. Each of the first and second track elements has an interface portion 158 arranged to slide relative to each other in a longitudinal direction to provide a continuous track surface extending from the first track element 156a to the second track element 156b suitable for guiding a load handling device across the expansion joint. The expansion joint at the interface in the portal 48 comprises a pair of expansion joints 154 to cater for the wheels of the load handling device. An example of the expansion joint is described in WO 2023046684 (Ocado Innovation Limited), the details of which are incorporated herein by reference. However, the expansion joint is not limited to the expansion joint shown in FIGS. 14A-14B and can be any type of expansion that allows movement in a longitudinal direction of the sets of parallel tracks extending between the first temperature zone and the environmental controlled enclosure. For example, the first and second track elements can be configured to slide relative to one another in a longitudinal direction in a junction area where they overlap.

To preserve the insulating properties of the closeable door in the portal 48 when accommodating the expansion joint 154 and to prevent the ingress of cold air from the storage area 45 into the environmental controlled enclosure 52, the expansion joint can be housed within one or more cut-outs 162 of the insulating door frame 160 shown in FIG. 15. Housing the expansion joint or tracks within the one or more cut-outs of the insulating door frame prevents condensation of the water vapor and subsequent freezing of the condensed water on the tracks. Whilst FIGS. 14A-14B shown in the expansion joint 154 at the junction between the storage area 45 and the environmental controlled enclosure 52, the expansion joint can also be present in the set of parallel tracks at the junction or interface between the environmental controlled enclosure 52 and the second enclosure 146 as shown in FIGS. 8, 10 and 13 to cater for the different levels of thermal expansion or contraction of the tracks between the environmental controlled enclosure 52 and the second enclosure 146. Like the interface between storage area 45 and environmental controlled enclosure 52, the portion of the set of parallel tracks 50 residing in the environmental controlled enclosure 52 can be termed a first portion of parallel tracks and the portion of the set of parallel tracks residing in the second enclosure 146 is termed a second portion of parallel tracks. The expansion joint bridges the first and second portion of parallel tracks. As a result, there are two sets of expansion joints. A first set of expansion joints bridges the parallel tracks between the storage area 45 and the environmental controlled enclosure 52 and the second set of expansion joints bridges the parallel tracks between the environmental controlled enclosure 52 and the second enclosure 146.

In addition to or alternatively to providing a heating chamber 66 in the environmental controlled enclosure 52, one or more fans (not shown) can be used to replenish the “cold” air surrounding the robotic load handling device. As the air surrounding the robotic load handling device is approximately at the temperature of the air in the storage area when initially entering the environmental controlled enclosure, the one or more fans can replenish the air surrounding the robotic load handling device with warmer air from the environmental controlled enclosure. By replenishing the air surrounding the robotic load handling device in the environmental controlled enclosure also helps to mitigate condensation of moisture in the environmental controlled enclosure since the robotic load handling device would be constantly exposed to fresh ‘dry’ air.

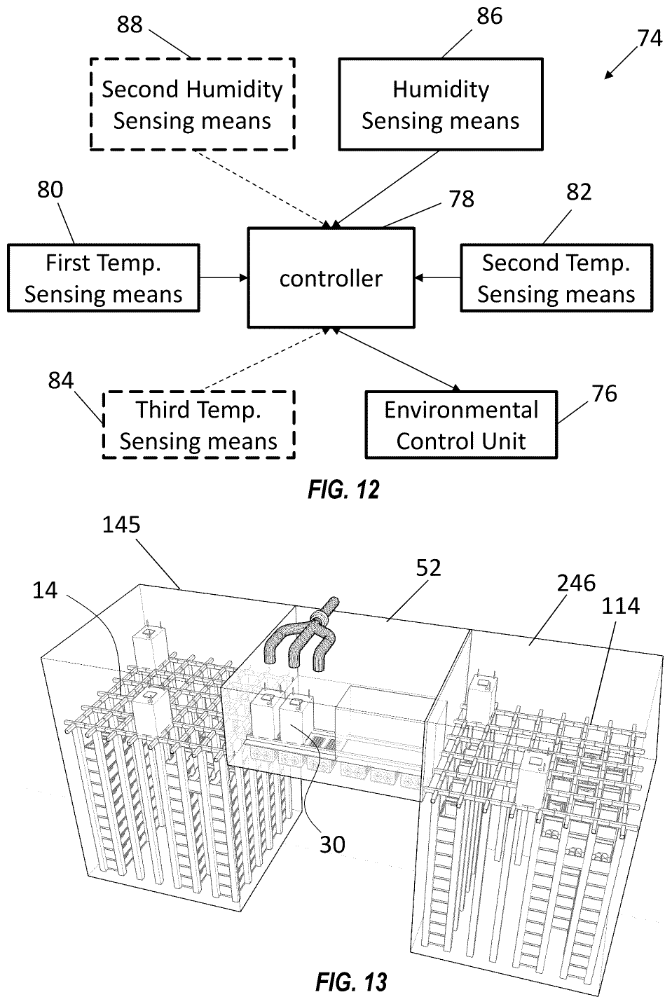

In operation when moving a robotic load handling device from the first enclosure 145 to the second enclosure 146 via the environmental controlled enclosure 52, an environmental control system 74 is configured to control the environmental control unit (or environmental control enclosure) 76 comprising the heating system and/or a dehumidifying system to provide at least one an environmental condition in the environmental controlled enclosure in anticipation of opening the first door and/or the second door of the environmental controlled enclosure. FIG. 12 is a block diagram of the environmental control system 74 for controlling the environmental condition of the air in the environmental controlled enclosure according to an exemplary embodiment of the present invention. The environmental control system comprises a controller 78, the first temperature sensing means 80 indicative of the temperature of the air or the robotic load handling device in the first enclosure 145, the second temperature sensing means 82 indicative of the temperature of the air or the robotic load handling device in the environmental controlled enclosure 52, the third temperature sensing means 84 indicative of the temperature of the air or the robotic load handling device in the second enclosure 146 and the humidity sensing means 86 indicative of the relative humidity of the air in the environmental controlled enclosure 52. The controller 78 is configured to receive temperature data from the first and second temperature sensing means 80, 82 and humidity data from the humidity sensing means 86 discussed above, and process the temperature and humidity data from the second temperature sensing means 82 and the humidity sensing means 86 to indicate a dew point or dew point temperature of the air within the environmental controlled enclosure 52. Known models can be used to calculate the dew point from the temperature and relative humidity readings. These include but is not limited to Magnus formula or Arden Buck. In the particular example, the dew point was calculated using the Magnus formula. The controller 78 comprises one or more processors configured to execute out instructions stored in a memory (e.g. read only memory). The instructions include but is not limited to determining the dew point, regulating the temperature and/or the humidity in the environmental controlled enclosure.

In an exemplary embodiment of the present invention, the controller 78 can be instructed to control the environmental control unit 76 comprising the heating system and/or the dehumidifying system to regulate the relative humidity at a given temperature in response to the temperature readings from the first temperature sensing means 80, second temperature sensing means 82, third temperature sensing means 84 and the humidity sensing means 86 such that the calculated dew point temperature of the air in the environmental controlled enclosure is below the temperature readings from the first temperature sensing means 80. Since the temperature of the air in the first enclosure measured by the first temperature sensing means 80 is below the temperature of the air in the second enclosure measured by the third temperature sensing means 84 then the calculated dew point in the environmental controlled enclosure 52 is also below the temperature of the air in the second enclosure. Knowing that the temperature of the air in the first enclosure 145 and the second enclosure 146 can be regulated at a fixed or steady temperature, then the controller 78 can be configured to regulate the relative humidity to maintain a predetermined relative humidity of the air in the environmental controlled enclosure at a predetermined temperature. For example, where the temperature of the air in the first enclosure 145 is regulated at −25° C. to define a freezer zone and the temperature of the air in the second enclosure 146 is regulated at 4° C., then the controller 78 can be instructed to control the environmental control unit 76 to regulate the moisture content at a relative humidity of about 10% at 4° C. in order to achieve a dew point of −26° C.

In a second exemplary embodiment of the present invention, the environmental condition in the environmental controlled enclosure can be dynamically controlled depending on the environmental condition in the first enclosure 145 and the second enclosure 146. With reference to FIG. 12, the moisture content of the air in the second enclosure 146 can be measured by a second humidity sensing means 88. In conjunction with the temperature reading from the third temperature sensing means 84, the controller 78 can be configured to determine a second dew point of the air in the second enclosure 146. The block diagram depicting the third temperature sensing means 84 and the second humidity sensing means 88 are shown as a dashed line to indicate the measurements taken in the second enclosure. Thus, in anticipation of opening the first door 150a to the environmental controlled enclosure 52, the controller 78 can be configured to control the environmental control unit 76 to provide a first environmental condition to mitigate the risk of condensation when a robotic load handling device enters the environmental controlled enclosure 52 from the first enclosure 145 and to provide a second environmental condition to mitigate the risk of condensation when a robotic load handling device enters the second enclosure 146 from the environmental controlled enclosure 52. In the first case discussed above, the first environmental controlled condition indicates a first dew point in the environmental controlled enclosure 52 below the temperature from the first temperature sensing means, e.g. −26° C., and in the second case, the second environmental condition indicates a second dew point in the second enclosure 146 below the temperature of the air or the robotic load handling device leaving the environmental controlled enclosure.

The advantage of dynamically controlling the environmental condition in the environmental controlled enclosure as opposed to regulating the temperature of the air in the environmental controlled enclosure to be equivalent to the temperature of the air in the second enclosure, is that the second enclosure can be set to a much higher temperature, e.g. greater than 4° C. This is because the controller can be configured to dynamically control the environmental control unit 76 to cater for the environmental condition in the second enclosure. For example, once the robotic load handling device has acclimatized to the first environmental condition in the environmental controlled enclosure to mitigate the risk of condensation when entering from the first enclosure, the controller can be configured to control the environmental control unit to condition the robotic handling device to mitigate the risk of condensation in anticipation of opening the second door to the second enclosure. Thus, there could be a two stage acclimatization of the robotic load handling device in the environmental controlled enclosure. The first will be to acclimatize the robotic handling device to the first environmental condition to mitigate the risk of condensation when opening the first door and the second will be to acclimatize the robotic load handling device to the second environmental condition to mitigate the risk of condensation when opening the second door. For example, if the temperature of the air in the second enclosure is 16° C. at a relative humidity of 50% giving a dew point of about 6° C., then the robotic load handling device is heated to a temperature of above than 6° C., e.g. 10° C., to mitigate the risk of condensation. As with the environmental control unit, the moisture content, i.e. the relative humidity, of the air in the second enclosure can be controlled by a second dehumidifier to ensure that the dew point of the air do not exceed the temperature a robotic load handling device when entering from the environmental controlled enclosure. In both exemplary embodiments discussed above, the controller controls the environmental control unit to at least one environmental condition such that the dew point in a given time in the environmental controlled enclosure is substantially at or less than the temperature of the first enclosure.

Whilst both exemplary embodiments discussed above, describes the second enclosure as a maintenance area or service station for serving or repairing one or more robotic load handling devices operational on the grid framework structure in the first enclosure, the second enclosure 246 can optionally comprise a second grid framework structure 114 defining a second storage and retrieval system (see FIG. 13). The first enclosure 145 defining a first storage and retrieval system. The second grid framework structure 114 of the second enclosure 246 is different to the second grid framework structure 58 of the environmental controlled enclosure discussed above. Like the first grid framework structure 14 in the first enclosure 145, the second grid framework structure 114 of the second enclosure 246 provides a storage area and a track system for one or more robotic load handling devices to move on the second grid framework structure 114. The storage area comprises a plurality of storage columns for the storage of stacks of storage containers in the plurality of storage columns as discussed above. The first enclosure 145 can define the freezer zone and the second enclosure 246 can define the chilled zone. One or more robotic load handling devices can be shared between the freezer zone and the chilled zone by being conditioned or acclimatized in the environmental controlled enclosure 52 when transitioning between the freezer zone and the chilled zone. This removes the need to have dedicated robotic load handling devices in each of the freezer zone and in the chilled zone. Equally, by sharing one or more robotic load handling devices between the first and second storage and retrieval systems, increases the capacity of one or more robotic load handling devices being operational in anyone of the first or second storage and retrieval systems. For example, where there is an increase demand for chilled goods, more of the robotic load handling devices can be assigned to the second enclosure from the first enclosure. Likewise, where there is an increase demand for freezer goods, more of the robotic load handling devices can be assigned to the first enclosure from the second enclosure. In both cases, one or more robotic load handling devices is conditioned in the environmental controlled enclosure to mitigate the risk of condensation when moving between the first and second storage and retrieval systems.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A multi-temperature storage system, comprising:
a first enclosure defining a first temperature zone, the first enclosure comprising a grid framework structure comprising a plurality of storage columns for storing a plurality of stacks of a plurality of storage containers, a track system arranged above the plurality of storage columns for guiding one or more robotic load handling devices on the grid framework structure;
a second enclosure defining a second temperature zone, the second enclosure being configured to accommodate one or more load handling devices from the first enclosure;
a cooling system configured to maintain a first temperature in the first temperature zone, the first temperature of the first temperature zone lower than a second temperature of the second temperature zone;
an environmental controlled enclosure (ECE) comprising a first opening and a second opening for linking the first enclosure and the second enclosure respectively such that a load handling device can move between the first and second enclosures via the ECE, the first and second openings being independently closeable by a first door and a second door, respectively, to selectively isolate the ECE from the first enclosure or the second enclosure;
an environmental control unit configured to heat or dehumidify air in the ECE; and
an environmental control system configured to control the environmental control unit to provide a first environmental condition in the environmental controlled enclosure in anticipation of opening the first door or the second door.

2. The multi-temperature storage system of claim 1, wherein the environmental control unit comprises a heating system or dehumidifier.

3. The multi-temperature storage system of claim 1, wherein the environmental control system comprises:
a controller;
a first temperature sensing means configured to measure the first temperature of the air or the one or more robotic load handling devices in the first enclosure;
an ECE temperature sensing means configured to measure an ECE temperature of the air or a load handling device in the ECE; and
a humidity sensing means configured to measure a first relative humidity of the air in the ECE;
wherein the controller is configured to:
receive a plurality of first temperature data from the first temperature sensing means;
receive a plurality of ECE temperature data from the ECE temperature sensing means;
receive a plurality of first humidity data from the humidity sensing means;
process the plurality of ECE temperature data and the plurality of first humidity data to indicate a dew point within the ECE; and
control the environmental control unit with respect to the first environmental condition such that the dew point in a given time in the ECE is substantially at or less than the first temperature from the first temperature sensing means.

4. The multi-temperature storage system of claim 3, wherein the ECE comprises a heating chamber for housing the one or more robotic load handling device, the heating chamber comprising at least one heating device for heating the one or more robotic load handling devices housed within the heating chamber.

5. The multi-temperature storage system of claim 3, wherein the ECE temperature sensing means is configured to measure the ECE temperature of one or more components of the load handling device in the ECE.

6. The multi-temperature storage system of claim 3, wherein the controller is configured to control the environmental control unit to regulate the first environmental condition to provide a predetermined dew point in the ECE.

7. The multi-temperature storage system of claim 3, wherein the environmental control system further comprises a second temperature sensing means configured to measure the second temperature of the air or the one or more robotic load handling devices in the second enclosure.

8. The multi-temperature storage system of claim 7, wherein the controller is configured to control the environmental control unit to regulate the first environmental condition in the ECE at the ECE temperature measured from the ECE temperature sensing means being substantially equal to the second temperature measured from the second temperature sensing means.

9. The multi-temperature storage system of claim 8, wherein the controller is configured to control the environmental control unit to regulate the first relative humidity in the ECE to maintain a predetermined relative humidity in the ECE at the ECE temperature measured from the ECE temperature sensing means being substantially equal to the second temperature measured from the second temperature sensing means.

10. The multi-temperature storage system of claim 7, wherein the controller is configured to control the environmental control unit to dehumidify the air in the ECE at the ECE temperature measured from the ECE temperature sensing means being substantially equal to the second temperature measured from the second temperature sensing means.

11. The multi-temperature storage system of claim 6, wherein the environmental control system further comprises a second humidity sensing means configured to measure a second relative humidity of the air in the second enclosure, wherein the controller is further configured to:
receive a plurality of second temperature data from a second temperature sensing means;
receive a plurality of second humidity data from a second humidity sensing means;
process the plurality of second temperature data and the plurality of second humidity data to indicate a second dew point within the second enclosure;
compare the second dew point with the plurality of second temperature data from the ECE temperature sensing means; and
if the plurality of second temperature data from the ECE temperature sensing means is at or below the second dew point, control the environmental control unit to provide a second environmental condition in the ECE such that the second dew point in a given time in the second enclosure is substantially at or below the ECE temperature measured from the ECE temperature sensing means.

12. The multi-temperature storage system of claim 11, wherein the controller is configured to control the environmental control unit to regulate the second relative humidity in the ECE at a temperature measured from the ECE temperature sensing means being substantially equal to the temperature measured from the second temperature sensing means such that the second temperature from the second temperature sensing means is at or above the second dew point.

13. The multi-temperature storage system of claim 11, wherein the second environmental condition is substantially equal to the first environmental condition.

14. The multi-temperature storage system of claim 7, wherein the plurality of first temperature data from the first temperature sensing means is in a range of from −18° C. to −30° C.

15. The multi-temperature storage system of claim 7, wherein the plurality of first temperature data from the first temperature sensing means is in a range of from −10° C. to 8° C.

16. The multi-temperature storage system of claim 1, wherein the environmental control unit comprises one or more fans for circulating the air in the ECE.

17. The multi-temperature storage system of claim 1, wherein the cooling system comprises a first refrigerating unit for cooling the air inside the first enclosure and a second refrigerating unit for cooling the air inside the second enclosure.

18. The multi-temperature storage system of claim 1, wherein the environmentally controlled enclosure comprises a set of parallel tracks extending from the track system in the first enclosure into the ECE.

19. The multi-temperature storage system of claim 18, wherein the set of parallel tracks comprises a first portion of parallel tracks and a second portion of parallel tracks, the first portion of parallel tracks residing in the first enclosure and the second portion of parallel tracks residing in the ECE, wherein the set of parallel tracks further comprises an expansion joint interfacing the first and second portions of the parallel tracks to provide a continuous track surface extending in a longitudinal direction from the first portion of parallel tracks to the second portion of parallel tracks.

20. The multi-temperature storage system of claim 18, wherein the first enclosure defines a first storage and retrieval system and the second enclosure comprises a second grid framework structure comprising a plurality of storage columns for storing the plurality of stacks of the plurality of storage containers, a second track system arranged above the plurality of storage columns for guiding the one or more robotic load handling devices on the second grid framework structure to define a second storage and retrieval system, and wherein the set of parallel tracks extend from the ECE into the second enclosure to interconnect with the second track system.
